(19) United States
(12) Patent Application Publication
(10) Pub. No.: US 2007/0266025 A1
(43) Pub. Date: Nov. 15, 2007

(54) IMPLICIT TOKENIZED RESULT RANKING

(75) Inventors: Allen L. Wagner, Kirkland, WA (US); Stephen J. Butler, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/382,948

(22) Filed: May 12, 2006

(51) Int. Cl. G06F 7/00

(52) U.S. Cl. 707/7

(57) ABSTRACT

A unique system and method that facilitates providing customized search results for a particular user. The system and method involve tracking user interactions with respect to a list of search results for a given query. In particular, click content, click order, and time stamp data can be collected for each submitted query on a per-user basis. Analysis of the collected data can facilitate inferring the user's context or intention with respect to the submitted query to improve the relevancy of returned search results. In addition, the presentation or appearance of the search results can vary according to user preferences, user profile data, or user interests. Thus, different users who submit similar queries using the same or similar terms can receive different sets of search results.

### BACKGROUND

Searching has become such an important feature of applications and operating systems for computer users. Even more so, it has turned into a highly profitable sector within the computing marketplace. On the one hand, advertisers are buying keywords and/or paying a premium for a desirable listing position when certain search terms are entered. On the other hand, consumers are primarily focused on the quality of the search and often select the search application or engine based on its past performance or reputation.

Most commonly, users initiate text searches to look for specific content on the Internet, on their network, or on their local PC. A search request can be submitted in a variety of formats. The user can use keywords, a phrase, or any combination of words depending on the content he/she is seeking and the location of the search. The task of a search engine is to retrieve documents that are relevant to the user's query. However, relevancy for the particular user can be difficult to determine. Oftentimes, several documents exist that relate to the same or similar terms and the most relevant documents for this user depends on the user's context. Thus, ranking the retrieved documents may be the most challenging task in information retrieval. Since most users typically only look at the first few results at the top of the list (returned by the search engine), it has become increasingly important to achieve high accuracy for these results.

Conventional ranking systems continue to strive to produce good rankings but remain problematic. This is due in part to the massive amount of documents that may be returned in response to a query. To put the problem into perspective, there are approximately over 25 billion documents (e.g., websites, images, URLs) currently on the Internet or Web. Thus, it is feasible that thousands if not millions of documents may be returned in response to any one query. Despite attempts made by traditional search systems to accurately rank such large volumes of documents, the top results may still not be the most relevant to the query and/or to the user. This is because many of these search systems rely on user rating to determine whether a search result is relevant. Unfortunately, user rating systems can be cumbersome and susceptible to fraudulent use and abuse.

### SUMMARY

The subject application relates to a ranking system(s) and/or methodology that facilitate fine tuning a search engine based in part upon implicit interaction data obtained by monitoring viewing and selection behaviors. More specifically, the systems and methods presented herein involve tracking user interaction with respect to set of search results returned for a given query. Result items that are clicked on and viewed, the length of such viewing, the content of the item including its title, whether any embedded links in the items were clicked on, and whether the user narrowed the query or initiated a new query can be examined to determine the relevancy of each item for the given query. In addition, personal data with respect to the user can be analyzed as well to better understand the context of the query for the current user and as well as other users with similar backgrounds or interests.

Unlike conventional ranking systems, the subject systems and methods also evaluate the items which have been skipped or ignored by the user. For instance, a user may be presented with dozens of pages of results. The system can observe that the user skipped particular items on page 1, all items on pages 2 and 3, but printed numerous items on page 4. The skipped items can be examined based on their title and/or the (truncated) description summary presented to the user in the search results list. This information can be compared with the items the user did select (e.g., viewed for longer than time W, printed, saved, bookmarked, or emailed). Furthermore, the presentation of the skipped items versus the selected items can be compared as well. Some users may be more responsive to one presentation type over another perhaps due to demographics such as age, ethnicity, occupation, education, and location or due to interests. Thus, the presentation of the result item can influence whether it is selected or skipped. By understanding these types of nuances among users, content owners can readily improve their site traffic by customizing the presentation or delivery of their content according to user preferences.

In addition, the order of items selected for viewing can be tracked and used to determine an item's relevancy for the current query. For example, the fact that the user selects an item near the bottom of a search result list before selecting an item in the middle of the list can be indicative of the user's context or intentions associated with the subject query. The system can also correlate the order of items clicked with the current query terms. These various types of data can be collected, analyzed, and employed to adjust the item's score or weight for the current query as well as for future queries and/or users that are similar in some aspect (e.g., field of interest). Hence, the search engine can be fine tuned to return more relevant results.

Content owners can also make valuable use of this data in order to determine whether their title or item summaries should be modified to mitigate getting skipped or ignored. In addition, they can offer different presentation views of their content. For example, a certain search result item may be relevant to both a 13 year-old girl and a 45 year-old business executive. However, the teenage school girl may be more likely to click on a colorful or animated result item with graphics whereas the business executive may prefer standard text font in a standard size and block set format.

The subject systems and methods can be incorporated primarily on the client-side, primarily on the server-side, or distributed between the client machine and the server. Furthermore, encryption can be employed to protect information that is communicated between the client and the server to mitigate abuse of the system.

The above discussion of the subject application provides a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a ranking system that facilitates improving the relevancy of query results returned for a particular user based in part on their behavior, interests, profile data, and by inferring their intentions.

FIG. 2 is a block diagram of a ranking system that monitors and records user click behavior, interests, and activity with respect to a given set of search results in order to facilitate improving the relevancy of such results for the particular user.

FIG. 3 is a block diagram of a ranking system that tracks user responses and feedback with respect to one or more search results for a given query and adjusts ranking scores for such results accordingly.

FIG. 4 is a block diagram that demonstrates interactions between a client and a server for tracking user behavior with respect to a set of result items for a given set of query terms and adjusting the items' scores based on their relevancy to the query terms.

FIG. 5 is a block diagram that demonstrates interactions between a client and a server for providing query results in a customized manner according to client filter(s).

FIG. 6 is a flow diagram illustrating an exemplary methodology that facilitates fine-tuning a search engine based on various factors such as user click behavior, click order, and/or user input or response to the search result items.

FIG. 7 is a flow diagram illustrating an exemplary methodology that facilitates providing more relevant search results to the user using the method of FIG. 6 in a customized manner according to one or more user filters or user demographic data.

FIG. 8 is a flow diagram illustrating an exemplary methodology that facilitates collecting and aggregating data from multiple searches by multiple users and their responses to the corresponding result items in order to improve the overall relevancy of search results.

FIG. 9 is a flow diagram illustrating an exemplary methodology that facilitates improving the relevancy of search result items based in part on the particular user's personal data and preferences.

FIG. 10 illustrates an exemplary environment for implementing various aspects of the invention.

### DETAILED DESCRIPTION

The subject systems and/or methods are now described with reference to the drawings, wherein like reference numerals are used to refer to like elements throughout. In the following description, for purposes of explanation, numerous specific details are set forth in order to provide a thorough understanding of the systems and/or methods. It may be evident, however, that the subject systems and/or methods may be practiced without these specific details. In other instances, well-known structures and devices are shown in block diagram form in order to facilitate describing them.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject systems and/or methods can incorporate various inference schemes and/or techniques in connection with estimating or determining user intentions with respect to a given query. In particular, the system can infer a user's intentions as it relates to their search or query terms based in part on their personal user data such as demographic information, geographic location, occupation, level of education, and/or historical data such the user's previous queries and/or previous item selections. In addition, click behavior and click order of items can be tracked and employed to infer the relevancy of certain items for the given query. The user's response to any one search result item as well as whether the search terms were modified (e.g., narrowed) or replaced with a new terms can also be used to indicate the apparent relevancy of the items to the user and to improve the results returned for similar searches performed in the future (by the same user or different users).

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

When dealing with a large set of content whether on the Internet or some other network, the effectiveness of a search may be limited to no more than a few sets of results pages. For common terms or terms with multiple meanings depending on the context, the desired items can be several pages deep into the search results. There are several well-documented techniques to improve the relevancy of search results returned. For example, some search engines change the weightings of the results through editorial means or by allowing users to rate the results. Unfortunately, conventional rating systems can be cumbersome and tend to be susceptible to abuse or fraudulent use. As will be described in further detail below, the subject systems and methods extract user behavior to determine search result relevancy and improve item rankings in order to fine tune search engine performance. In addition, user behavior can also be examined in order to personalize the content and presentation of search results for each user.

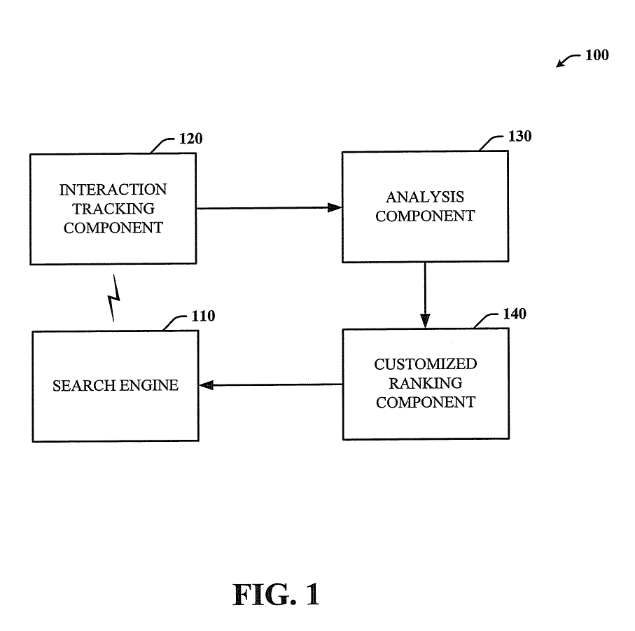

Referring now to FIG. 1, there is a general block diagram of a ranking system 100 that facilitates improving the relevancy of query results returned for a particular user based in part on their behavior, interests, profile data, and by inferring their intentions. The system 100 includes a search engine 110 that processes a given query and returns a set of results to the user. An interaction tracking component 120 can monitor and track the user's interactions or behavior with respect to the set of results. For example, the interaction tracking component 120 can record which result items are clicked, the duration of time that each clicked item was viewed, whether the “back” button was clicked and if so, how soon after was it clicked (e.g., within a few seconds after the item was clicked). In addition, the interaction tracking component 120 can track which items have been skipped or ignored. For example, the title or presentation of the skipped items can be extracted. The tracked and extracted data can be analyzed by an analysis component 130. The analysis component 130 can examine this data alone or together with available user data including but not limited to demographic information, personal interests, preferences, and previous searches. A customized ranking component 140 can then be employed to adjust scores or weights for the respective items based on the apparent relevancy of the items to the particular user with respect to the given query terms. Thus, item scores can be customized for each particular user. Ultimately, the search engine 110 can be fine tuned for subsequent query processing.

In practice, imagine that a user enters the following query: WHILE. The user is a computer programmer and thus the context of the query term is computer programming; however a conventional search engine is unaware of the context of the query and unaware of the user's background or interests. As a result, hundreds if not thousands of pages of results may be returned to the user. Now envision that the subject ranking system 100 is employed. The system 100 can track the user's interactions with the result items. For example, the user skips pages 1 and 2 entirely and clicks on item #3 on page 3. Within a second, he clicks a BACK button to return to the list of results. Though he initially skipped item #1 on page 3, he subsequently clicks on item #1. After viewing the content of this item for a few minutes, he returns to the list of results and enters a new query.

The tracking component 120 can track a number of interactions between the user and this set of result items and later employ them to customize the ordering of items most relevant to this user. For instance, the tracking component 120 can record or make note that the items on pages 1 and 2 were skipped and compare their titles, brief summaries (if provided), associated keywords, and/or content with any items the user positively selected. A positive selection can refer to any result item that the user printed, emailed, saved, bookmarked, and/or viewed for a threshold amount of time—before clicking a “back” or “next” button or before submitting a new query. Assuming that the number of minutes satisfies the threshold, item #1 on page 3 can be one example of a positive selection.

By contrast, a negative selection can refer to any result item that was selected (or clicked on) by the user but the time elapsed between the selection click and a “back” or “next” button click fails to satisfy the threshold. Item #3 on page 3 is an example of a negative selection in this scenario. Similar information associated with item #3 on page 3 can also be compared with the corresponding information associated with item #1 on page 3 in order to determine the user's context or intention for performing the query.

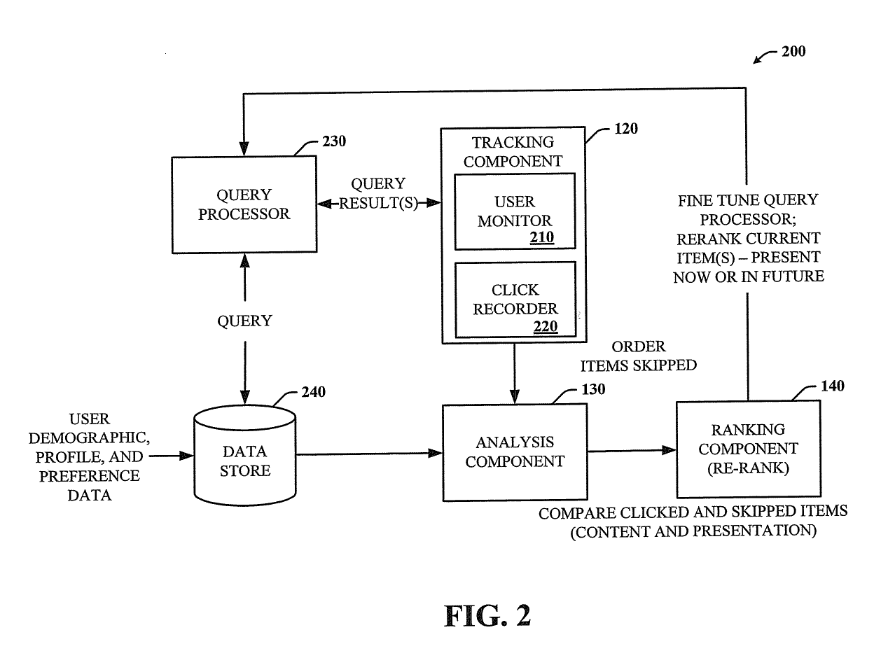

Furthermore, suppose item #1 on page 3 included additional links to other articles and the user positively selected one of them as well. The link can be examined for at least its name or title which can provide further insight as to the user's context or intentions. If the link is also found in the search results, its rank or score can be adjusted accordingly to reflect its relevancy for the current user or for other users with similar backgrounds or interests (e.g. computer programming). FIG. 2, infra, discusses this aspect in greater detail.

Based on the analysis of the tracked data as it relates to the current query terms, the customized ranking component 140 can adjust the scoring and ordering of result items in the current search and/or in future searches so that the items most relevant to the particular user appear higher in the results list and the lesser or least relevant items appear near the bottom of the list. In some cases, the customized ranking component 140 can remove the least relevant items from the list to mitigate waste of the user's time in showing him/her irrelevant content. The customized ranking component 140 adjusts scores, weights, and other related ranking values according to each user or according to a group of similar users based on demographics, backgrounds, or interests. Thus, for the subject computer programming user, documents including the term WHILE regarding computer programming languages, etc. can have a higher score or weight for this user than for an English doctoral candidate who is studying the origins and grammar usage of the term WHILE and submits the same query.

Turning now to FIG. 2, there is a block diagram of a ranking system 200 that monitors and records user click behavior, interests, and activity with respect to a given set of search results in order to facilitate improving the relevancy of such results for the particular user. The system 200 includes a tracking component 120 that can monitor user behavior via a user monitor 210 and record user clicks via a click recorder 220 with respect to a set of query results. A query processor 230 generates a set of query results for a given query. Each submitted query can be stored in a data store 240 along with any user-related data such as the user's demographic information, user profile, and user preferences.

An analysis component 130 can evaluate the user's behavior and tracked click data in view of the user's current query, past queries, and at least a portion of any user data maintained in the data store 240. The analysis component 130 can compare clicked and skipped items to each other. In addition, these items can be compared to any positive selections the user may have made. The analysis of the click data and any other user behavior are associated with a given query or set of query terms. By doing so, any items can be ranked or associated with one another in a consistent manner according to the particular query. For example, a positive selection can include 10 other links. The user clicks on at least one of them. The system 200, or more specifically, the ranking component 140 can associate the clicked link back to the original query and can either add it as a relevant document in future searches or adjust its ranking upward if it was already included in the original set of results. Further nested links can be associated with the original query as well. For instance, the clicked link can also include yet another link which the user clicks and so on to form a chain of links. Each link regardless of its position along the chain can be associated with the original query.

The ranking component 140 can employ any analysis of the user's behavior and/or tracked data to fine tune the query processor 230 for future searches and/or re-rank the current result items. More specifically, the query processor 230 can be fine-tuned and customized for each particular user based on their demographic, profile or other background information. For example, Jane is 16 years old and has been researching various cars on the Internet for the past 6 months. Her online browsing and searching behavior has been monitored for at least a portion of this time.

Taking her browse and search history such as the pages she has visited, query terms, and/or positive and negative selections she made during that time together with her demographic data including her age, the analysis component 130 can infer with a threshold degree of certainty that Jane has an interest in cars and due to her age, may in fact be looking for a car to purchase. Therefore, when Jane subsequently performs a query for SATURN, the tracked, monitored, and/or stored user data can be evaluated to infer or determine that Jane is most likely interested in the car manufacturer named SATURN rather than the planet SATURN. Thus, any result items involving cars can be re-ranked by the ranking component 140 for Jane so that when she performs a search on the term SATURN, her results list includes car related pages at or closest to the top of the list while pages on the planet are at or near the bottom of the list. The same or similar results list can be generated for other users who have similar demographic data or browsing histories. Moreover, the ordering or ranking of items on the results list can be customized according to the specific user.

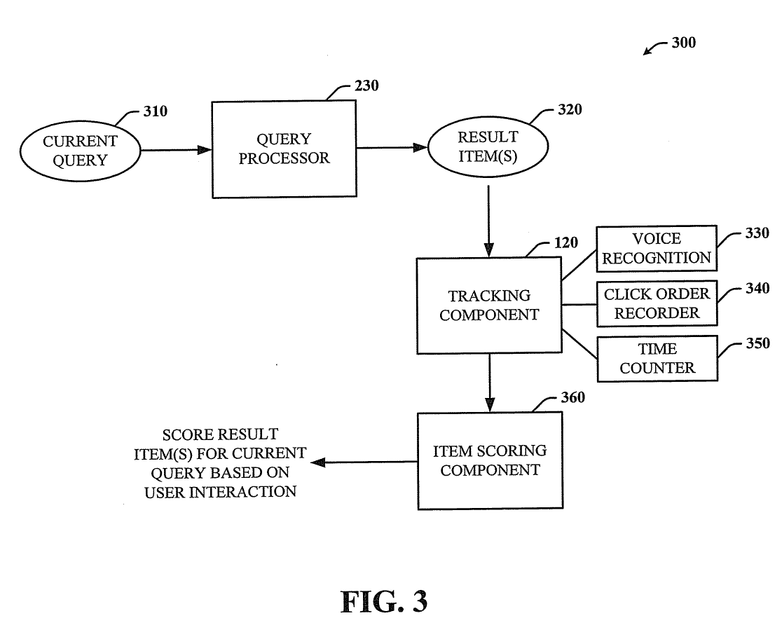

Referring now to FIG. 3, there is a block diagram of a ranking system 300 that tracks user responses and feedback with respect to one or more search results for a given query and adjusts ranking scores for such results accordingly. The system 300 also includes the query processor 230 which processes a current query 310 and generates result items 320 that appear to be the most relevant to the user and to the current query. The result items can be presented to the user, whereby the user's responses or lack of response can be tracked by the tracking component 120. Depending on the display or device the user is using, responses can be made verbally and analyzed using voice recognition techniques 330. In addition to the verbal content of the response, voice tones and inflections can be detected and valued. Click responses can also be tracked via a click order recorder 340 (similar to the click recorder 220). The click order recorder 340 can note when an item is clicked as well as the item's title or any other data extractable from the selected item. In addition, it can also note the order in which the items are clicked and employ the order information to approximate or determine the relevancy of the items to the user. For example, the fact that an item at the bottom of the page was clicked before an item at the top of the page can be indicative of the user's search context. Thus, the ordinals of the clicks such as the first click, the second click, the third click, and so on can provide meaningful information regarding the user's context or intentions with the current search.

Click order can also be helpful to content owners (e.g., website owners). For example, positive selections that are made on any click but the first click for a certain set of search terms can prompt content owners to examine why their items are not clicked first, are not clicked earlier (with a higher ordinal), or are not clicked before negative selections. The answer may lie in the content of the title or description and/or presentation of the items which the content owners can modify in order to improve their hit frequency and ultimately, their rankings for a given set of search terms.

Furthermore, click order can provide other useful information such as the user's preferred presentation mode (assuming that at least two result items are presented in a different manner). Users can be rather selective or finicky and some may tend to pick items with color, animation, graphics, and/or a non-standard font while others may prefer to stick to traditional text views. In order to accommodate the various types of users and their viewing preferences and to increase overall traffic to the content, a content owner (e.g., website owner) can offer multiple presentation views. The query processor and/or ranking component can select any one view for inclusion in the results list based on the current user. Otherwise, result items that are relevant to the user are more likely to go unnoticed or to be overlooked by the user due to its presentation.

The amount of time the user spends viewing a particular result item or other content can be recorded as well using a time counter 350. For instance, the time spent on a webpage can be compared to a threshold amount to determine whether the page was truly relevant to the user or whether the title appeared to be relevant but was quickly discovered to be irrelevant when the user viewed the page.

Once a sufficient or desired amount of tracked data is collected and analyzed, the result items can be re-scored accordingly by way of an item scoring component 360. The re-scored items can be stored for later retrieval and/or presented in a results list again for the current search. In practice, for example, the scores for skipped items can be lowered. Scores for negative selections can be lowered as well. Meanwhile, the scores for positive selections can be increased or can stay the same depending on their original score. In the latter scenario, a positive selection that occurs near or at the top of the results list may already have a high score. Hence, raising this score may not be necessary to reflect that it is very relevant to the user for the current search.

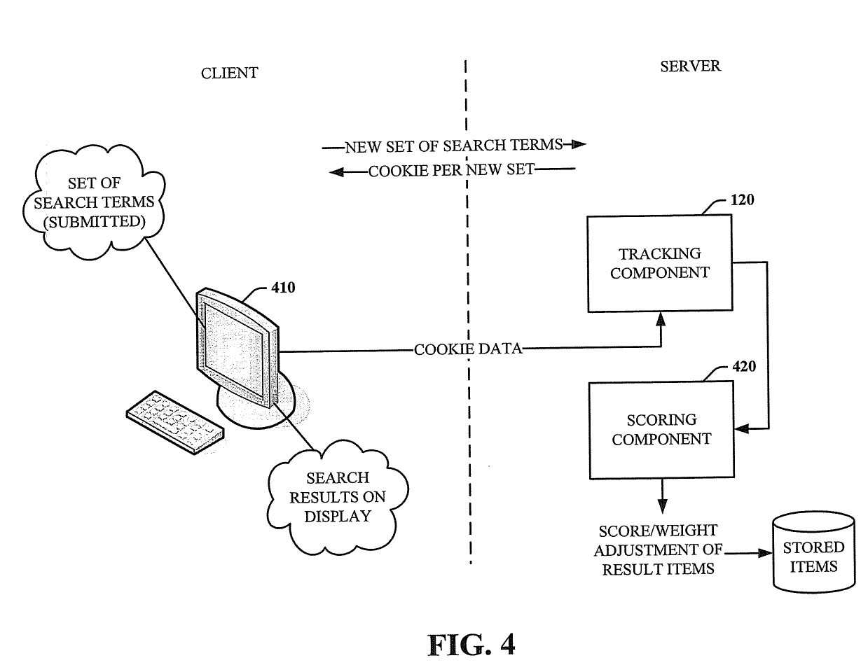

Turning now to FIG. 4, there is a block diagram that demonstrates exemplary interactions between an at least one client and an at least one server which facilitates tracking user behavior with respect to a set of result items for a given set of query terms. Imagine that a user has submitted a new set of search terms to a search engine. Each new set of search terms submitted to the search engine causes a persistent cookie to be created on the user's (client) machine 410. Following, a set of search results are displayed on the client machine 410. The cookie includes a credit counter with an arbitrary value, a time stamp, and a unique identifier that ties it to the set of search results. The counter value can also be encrypted to mitigate gaming of the set of results or abuse of the ranking system.

The user's click and viewing behavior with respect to the set of search results can be captured through the use of the cookie and the cookie data can be communicated to a tracking component 120 located on the server. In practice, suppose the user clicks on a result A. The tracking component 120 can record the clicked item and a scoring component 420 award a credit score to the result equal to the current counter value. Following, the counter is decremented and the machine can be redirected to the selected location. After skimming the article, the user decides that the article did not meet his needs and clicks on the “back” button in his browser to return to the set of search results. He then clicks on the next most attractive result B in the results list. The scoring procedure can be repeated again, crediting B. Result A initially did seem to be the most attractive article based on its headline or title and description, but the user quickly returned to the search results and selected another result item. Therefore, in addition to crediting B, A's score can be decreased because it did not meet the user's expectations despite its luring title and description. Scores credited to positive selections and adjusted scores to negative selections can be preserved and stored in a data store 430. Skipped items that were essentially ignored by the user can be scored accordingly as well to indicate that at least their title and description failed to convey any indications of relevancy to the user for the current search.

In some cases, the user may submit a new set of search terms. The new set can include some or all new keywords. If the new search occurs within a predetermined time limit (e.g. time threshold), the system can assume that the last set of results were failures and any accumulated credit scores for the last set of results can be removed. However, if the time limit to submit a new search is exceeded since the previous search, the credits awarded to the results can be preserved and subsequently employed to adjust the weight or rank scores of the affected result items. More than likely, subsequent searches past a certain time period are not refinements of the previous search.

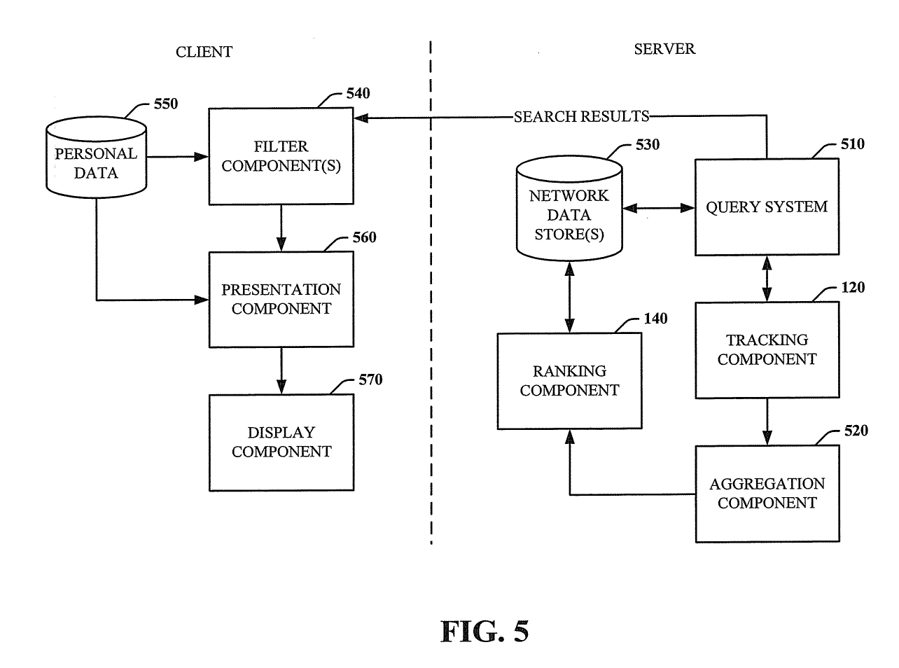

Moving on to FIG. 5, there is a block diagram that demonstrates exemplary interactions between a client and a server for providing query results in a customized manner according to one or more client filter(s). As shown in the diagram, the server can include a query system 510 that communicates with a tracking component 120 as described in FIGS. 1-4, supra. Data collected by the tracking component 120 from multiple machines can be communicated to an aggregation component 520 where it can be aggregated based on search terms, users, and user behaviors in order to re-score or re-rank one or more result items (via the ranking component 140). For instance, for a similar set of search terms, the aggregation component 520 can aggregate and coalesce tracking data from multiple users. Personal data from such users can also be employed to verify the context of the search terms. Items or content that are re-ranked or re-scored can be stored in one or more network data stores 530 for later retrieval when needed by the query system 510.

When a query is submitted to the query system 510, results can be provided to the client machine in a customized manner and order based on one or more filters located on the client. For example, a filter component 540 can filter the available set of results based on the user's stored personal data 550 and then present them to the user in a manner perhaps unique from other users (via a presentation component 560). In the end, a display component 560 can display the filtered results to the user.

The filter component 540 can re-order or exclude certain result items from the results list according to the user's background (e.g., occupation or interests) as well as demographic data such as the user's age, ethnicity, gender, and geographic location. For instance, imagine that George is a 50 year old business advertising executive and Susie is a ninth grader. They individually perform a search on the term CELL PHONE. Based on each of their personal data and filters, George's results can be filtered so that content including, for example, the latest cell phones, newest cell phone technologies, and/or national and international service plans appear near or at the top of his results list. Conversely, Susie's results can be filtered so that content including available and new ring tones and cell phone decorations (e.g., appliques, crystals, face plates, etc.) and colors can appear near or at the top of her results list. Hence, the results can be filtered according to the particular user given the same or similar set of search terms.

Furthermore, given the differences between George and Susie, the results can be presented in a different manner for both of them. George's results can appear in a plain standard font, font size, and font color whereas Susie can have her results customized to appear in different or alternating colors or even in a different layout altogether. By customizing the results list for each user according to their preferences or other personal data, the overall search experience can be improved.

Various methodologies will now be described via a series of acts. It is to be understood and appreciated that the subject system and/or methodology is not limited by the order of acts, as some acts may, in accordance with the subject application, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject application.

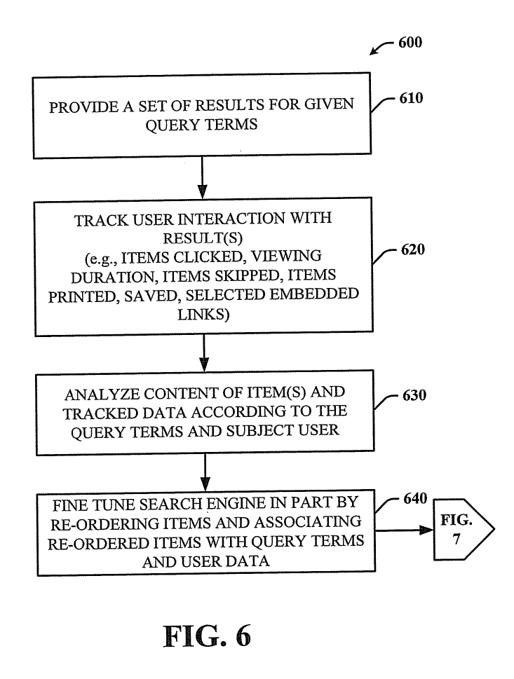

Referring now to FIG. 6, there is a flow diagram illustrating an exemplary methodology 600 that facilitates fine-tuning a search engine based on various factors such as user click behavior, click order, and/or some other user response to a set of search results. The method 600 involves providing a set of results for a given query at 610. At 620, user interactions with the set of results can be tracked. Examples of interactions include clicking on items, ignoring or skipping items, clicking a “back” or “next” button, saving, emailing, or printing the item, and/or selecting one or more links embedded in any item. The length of time that each opened item is viewed can also be recorded as well. This time period counter can begin when the user clicks on the item and stop when the back button is hit to return to the main set of results.

At 630, the content of any positive or negative selections and any skipped items can be analyzed together with any available user data to learn and assess what type or context of the content the user favored or disfavored. The content can include but is not limited to the title and description of the respective items. The analysis of the tracked data can be employed to fine-tune the search engine at 640. In particular, one or more result items can be re-scored and re-ordered with respect to the current query terms and user data in order to improve the relevancy of items presented to this user for the current query and/or for similar queries in the future.

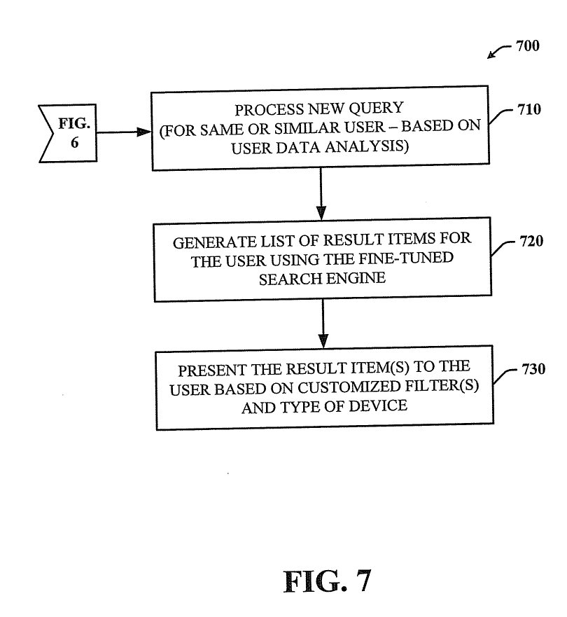

FIG. 7 can follow from FIG. 6. In FIG. 7, there is a flow diagram illustrating an exemplary method 700 that facilitates providing more relevant search results to the user using the method of FIG. 6 in a customized manner according to one or more user filters or user demographic data. In particular, the method 700 involves processing a new query for the same user or for a similar user at 710 using the fine-tuned search engine. Similar users can be determined according to an analysis of the user's personal data such as their backgrounds, interests, age, gender, ethnicity, geographic locations, occupations, and education.

At 720, a list of result items for the new query can be generated and at 730, the list can be further customized according to one or more filters and/or the type of device the user is using before it is presented to the user. For example, the presentation or layout of the results can be modified based on user preferences to appeal to various viewing penchants. In addition to modifying the visual appearance of the list, the order of the results can be modified or customized as well based on the user. For example, a parent looking for animal attractions to visit on vacation and who performs a search for primates most likely will not be interested in articles discussing recent primate studies on their mental and physical development. Instead, the parent is more interested in content that provides information about zoo locations or other wild animal parks. The converse would be true for a doctoral candidate studying primate youth behaviors. Thus, each user in this instance can submit the same or almost the same query terms and receive a customized list of results according to their personal interests.

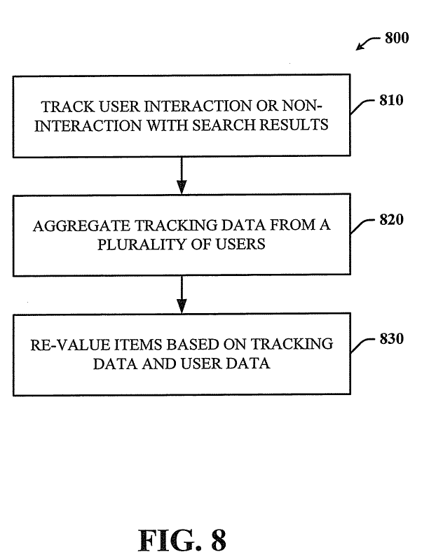

Turning now to FIG. 8, there is a flow diagram illustrating an exemplary method 800 that facilitates collecting and aggregating data from multiple searches by multiple users and their responses to the corresponding result items in order to improve the overall relevancy of search results. The method 800 involves tracking user interaction or non-interaction (e.g., skipping or bypassing results) with respect to discrete sets of search results and their corresponding search terms at 810 from multiple users. At 820, the tracked data can be aggregated and at 830, one or more result items can be re-scored accordingly.

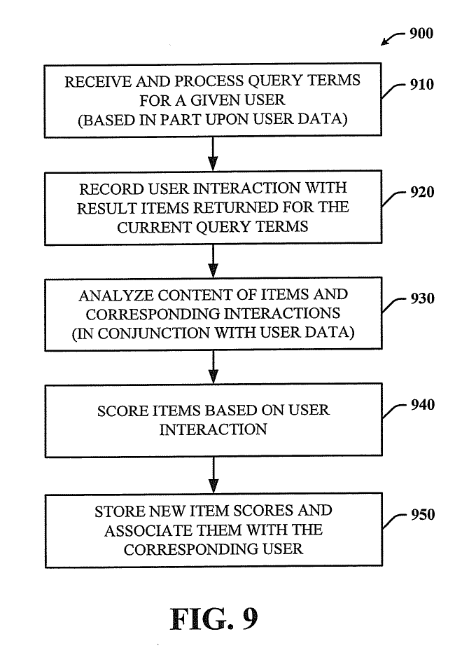

Referring to FIG. 9, there is a flow diagram illustrating an exemplary method 900 that facilitates improving the relevancy of search result items based in part on the particular user's personal data and preferences. In particular, the method 900 involves receiving and processing query terms from a certain user at 910. At 920, the user's interactions with regard to the returned results can be tracked and associated with the specific query terms. At 930, at least a portion of content of the items can be analyzed in conjunction with any available user data as well as the corresponding user interaction. For example, click order can be examined together with the title and/or description of the items. Looking at the user's personal data can also provide insight as to the user's context or intention for the search. Such analyses can facilitate determining which items from a list of result items are more relevant to the particular user. Following, one or more result items can be scored at 940 based on such analyses; or alternatively, their scores can be adjusted. The new scores for the respective items can be stored and associated with the query terms as well as the user in order to improve the relevancy of subsequent search results.

The systems and methods described hereinabove can be employed on any client and/or server machine. Examples of client machines include but are not limited to desktop computers, laptops, and/or mobile devices such as PDAs, smart phones, cell phones, and sub-compact or mini computers. In addition to typical server machines, some portable devices can also operate as servers.

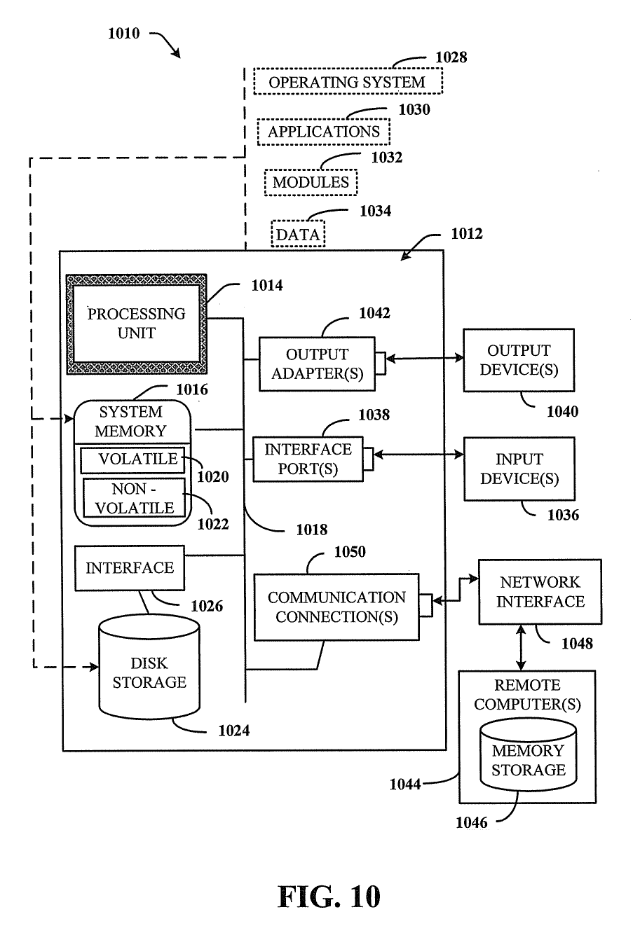

In order to provide additional context for various aspects of the subject invention, FIG. 10 and the following discussion are intended to provide a brief, general description of a suitable operating environment 1010 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1010 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject system and/or method. It is, of course, not possible to describe every conceivable combination of components or methodologies for purposes of describing the subject system and/or method, but one of ordinary skill in the art may recognize that many further combinations and permutations of the subject system and/or method are possible. Accordingly, the subject system and/or method are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ranking system that facilitates improving the relevancy of search results for a particular user comprising:
an interaction tracking component that monitors and tracks user interactions with respect to a given set of search result items;
an analysis component that examines the user interactions of the particular user for the given set of search result items; and
a ranking component that re-ranks one or more search result items in the given set based at least in part on the user interactions to facilitate customizing search results for the particular user.

2. The system of claim 1, wherein the analysis component evaluates at least a portion of user data to facilitate determining at least one of user context or user intention with respect to a given set of search terms.

3. The system of claim 2, wherein the user data comprises demographic information, personal interests, preferences, and previously submitted searches.

4. The system of claim 2, wherein the analysis component associates the user interactions with respect to the given set of search terms.

5. The system of claim 1 further comprising a scoring component that adjusts at least one of scores or weights of one or more items from the set of search result items according to the user interactions to affect a ranking of the items.

6. The system of claim 1, wherein user interactions comprise clicking on any one search result item, clicking on a back button, clicking on a next button, skipping one or more search result items, refining search terms, and submitting a new set of search terms.

7. The system of claim 1, wherein the tracking component comprises at least one of a click recorder, voice recognition module, and a time counter.

8. The system of claim 7, wherein the click recorder tracks at least one of click content and click order to facilitate improving relevancy of search result items returned to the user.

9. The system of claim 1, wherein the tracking component is located on a server and sends a persistent cookie to a client machine for each new submission of search terms to facilitate tracking the user's response to one or more result items returned for each respective set of search terms.

10. The system of claim 1 further comprising:
a search engine that generates one or more search result items for a given query; and
one or more filter components located on a client that filter the search result items based on user data to customize at least one of the following: appearance and presentation of at least one search result item and order of the search result items.

11. A method that facilitates improving the relevancy of search results for a particular user comprising:
tracking user interaction with respect to the one or more search result items;
analyzing at least a portion of content of the one or more search result items based on the user interaction with the items and user data; and
fine-tuning search results for a given set of search terms on a per-user basis based at least in part upon user interaction data for each particular user, wherein fine-tuning comprises re-ordering the search result items in a customized manner according to the user's interaction with them and the user's personal data.

12. The method of claim 11, wherein tracking user interaction comprises monitoring user behavior, recording click order and corresponding click content, recording skipped items, measuring elapsed time between clicks, and recording items that are at least one of printed, saved, bookmarked, or emailed.

13. The method of claim 11, wherein tracking user interaction comprises creating a persistent cookie on a client machine with each new set of search terms submitted for searching.

14. The method of claim 13, wherein the persistent cookie captures click data and a timestamp for each click.

15. The method of claim 11, wherein analyzing at least a portion of the content comprises analyzing at least a title of one or more of the items in conjunction with user interaction data and user data.

16. The method of claim 11, wherein fine-tuning search results comprises adjusting at least one of a score or a weight of each respective result item according to at least one of tracked data or user data.

17. The method of claim 11 further comprises aggregating user interaction data for the set of search terms from a plurality of users in order to facilitate improving search results returned to the plurality of users for the set of search terms.

18. The method of claim 11 further comprises filtering at least a portion of the search results items for at least one of presentation, source, and content according to user filter settings.

19. The method of claim 11 further comprises inferring at least one of user intention or user context with respect to the set of search terms based on the user interaction data and user data to facilitate the fine-tuning of future searches.

20. A ranking system that facilitates improving the relevancy of search results for a particular user comprising:
means for tracking user interactions with respect to a given set of search result items;
means for examining the user interactions of the particular user for the given set of search result items; and
means for re-ranking one or more search result items in the given set based at least in part on the user interactions to facilitate customizing search results for the particular user.
